(19) United States
(12) Patent Application Publication
(10) Pub. No.: US 2026/0240355 A1
(43) Pub. Date: Aug. 20, 2026

(54) CERAMIC BODY COFFEE MAKER

(71) Applicant: Clovermark Studios LLC, Brooklyn, NY (US)

(72) Inventor: Jeffrey Hannoosh, Brooklyn, NY (US)

(73) Assignee: Clovermark Studios LLC, Brookyln, NY (US)

(21) Appl. No.: 19/539,723

(22) Filed: Feb. 13, 2026

Related U.S. Application Data
(60) Provisional application No. 63/759,015, filed on Feb. 14, 2025.

(51) Int. Cl. A47J 31/057; A47J 31/02; A47J 31/06; A47J 31/42; A47J 31/46; A47J 31/56

(52) U.S. Cl. CPC A47J 31/0573; A47J 31/02; A47J 31/057; A47J 31/0631; A47J 31/42; A47J 31/465; A47J 31/56

(57) ABSTRACT

The present invention describes a novel design for an auto-drip coffee maker, vastly reducing the risk of chemicals leeching into the beverage by designing a system from water reservoir to hot-side brew path to carafe out of ceramic, glass, inert metals and food-grade silicone. A modern flow-through heating system provides precision brew temperatures and eliminates prolonged plastic contact (in a stainless-steel reservoir) and eliminates heated plastic contact (in the hot-side brew path). In addition to protecting consumers from the health risks associated with hydrocarbon-based plastics, the ceramic body coffee maker is engineered to ensure the cleanest-tasting water is delivered to the brew chamber at optimal brew temperatures to offer coffee lovers great tasting coffee.

### CROSS REFERENCE TO RELATED APPLICATION

The present application claims the benefit of co-pending U.S. Application No. 63/759,015 filed Feb. 14, 2025, entitled Ceramic Body Coffee Maker, the disclosure of which is incorporated by reference in its entirety.

### FIELD OF THE INVENTION

The field of the present invention generally relates to coffee makers, particularly automatic drip coffee makers.

### BACKGROUND OF THE INVENTION

Automatic drip coffee makers are well known in the art, typically comprising a fresh water reservoir to receive and hold fresh water, a heating element to heat the water for brewing (and in some instances to keep it warm in a carafe after brewing), a riser to raise the hot water to a shower over the brew chamber, a hot water shower from which water drips over a brew chamber containing ground coffee, and a brew chamber holding either a disposable or a reuseable coffee filter that retains the coffee grounds. The hot water drips through the coffee grounds and is collected in a carafe that is typically made of glass or stainless-steel.

The basic structure and approach to designing an auto-drip coffee maker is well known; however, as society becomes increasingly concerned about exposure to unhealthy and sometimes toxic chemicals leeching into food and drinks from hydrocarbon-based plastics, and concerned with the sheer amount of plastic being produced today, the design and material makeup of a traditional drip coffee maker is called into question. Nearly all auto-drip coffee makers are made of a large plastic body, and expose water heated to a high temperature to an extensive path of hydrocarbon-based plastic, including a plastic vessel, plastic tubes, a plastic hot water shower, and a plastic brew chamber. When hydrocarbon-based plastic materials used in a conventional coffee maker encounter water (and especially hot water), the plastic may leech chemicals into the water. The phenomenon is exacerbated by heat, prolonged exposure, and aged plastic. Society has yet to fully reckon with the range of chemical exposures we encounter daily, but it is commonly accepted as advisable to avoid the combination of heated liquids and hydrocarbon-based plastics in consumables. Likewise, reducing the presence of plastic in new consumer products can reduce the environmental impact of the new product lifecycle. Frankly, in some plastic appliances the water picks up a distinct plastic flavor—utterly ruining the beverage.

The present invention sets forth to redesign the auto-drip coffee maker to eliminate all contact with hydrocarbon-based plastic materials in the water reservoir and hot-side brew path by carefully considering the heating element, water lines, brew chamber and carafe, and to ensure that brewed coffee produced in an auto-drip coffee maker is not a source of chemical exposure from plastics. By redesigning the hot-side brew path of the classic auto-drip coffee maker exclusively from inert food-grade materials (such as ceramic, glass, stainless-steel, and food grade silicone) the health risks will be greatly reduced and coffee flavor will be improved as well. Additionally, the construction utilizes a stainless-steel brew chamber that is designed to preserve the heat of the coffee as it is brewed, resulting in the controlled temperature required to ensure optimal extraction and flavor. Furthermore, the ceramic body is more sanitary than a plastic body.

Devices have been disclosed in prior art that relate to coffee makers. These include devices that have been patented or published in patent applications. These devices generally relate to coffee makers having various constructions.

These prior art devices have several shortcomings. The devices in all but US 2016/0278568 fail to completely shield water and coffee from plastic exposure. Secondly, in the case of US 2016/0278568, the prior art depicts a ceramic brew chamber. The proposed ceramic brew chamber design will not facilitate coffee brewing at a temperature that will result in optimal flavor as ceramic will rest at the ambient room temperature and initially absorb heat rapidly during the brew process. Thirdly, no prior art exists illustrating a drip coffee maker with an entirely ceramic body and metal base. This construction is novel for an electric appliance and has the advantage of impermeability and more sanitary functionality.

The present invention substantially diverges in its functional design elements from the prior art and consequently it is clear that there is a need in the art for improvement to existing coffee maker devices. In this regard the instant invention substantially fills these needs.

### SUMMARY OF THE INVENTION

In the view of the foregoing disadvantages inherent in the known types of coffee makers now present in the prior art, the present invention provides a new coffee maker.

The present invention provides a drip coffee maker that reduces plastic contamination, starting with a plastic-free body (replacing it with a more sanitary ceramic body material), and utilizing components of ceramic, glass, stainless-steel, and food grade silicone, all to brew coffee at temperature that produces optimal flavor. The coffee maker is comprised of an upright ceramic body on a metal base, thereby eliminating a major plastic structure. This ceramic body and metal base serve as a structure to hold a stainless-steel reservoir, stainless-steel and food-grade silicone water lines, a heating element, a stainless-steel riser, a stainless-steel shower, and a stainless-steel brew chamber (of air gap insulated stainless-steel) (together the “Brew Path”), as well as a carafe of glass with a glass or stainless-steel lid to receive the brewed coffee and keep it warm until serving. In particular, the hot-side brew path (comprising the heating element, water lines, stainless-steel riser, stainless-steel shower, and stainless-steel brew chamber), are entirely free of hydrocarbon-based plastics. In this way, the reservoir and hot-side brew path are completely free of hydrocarbon-based plastic, the ceramic body is more sanitary, and the stainless-steel brew chamber is not subject to temperature reduction/heat absorption associated with ceramic.

The present invention can be configured as a classic drip coffee maker, whereby there is a heating element under the recessed heating plate (carafe tray) responsible for heating and percolating water from the Reservoir as well as for keeping the recessed heating plate (carafe tray) and thereby the carafe warm once brewed.

The present invention can be configured as a temperature-controlled drip coffee maker using a flow-through heating system. In such an embodiment, there would only be minimal plastic components in the pump itself (preferably an NSF certified pump). In this embodiment, plastic would be eliminated in every other contact point from the Reservoir to the carafe. Particularly, there would be no plastics in the Reservoir (where water could be left sitting for periods of time) and there would be no plastic from the heating element to the carafe (the “hot-side brew path”). The hot-side brew path can further comprise food-grade silicone water lines to plumb components within tight spaces. A separate heating element would still be used to warm the recessed heating plate (carafe tray).

### BRIEF DESCRIPTION OF THE DRAWINGS

Preferred and alternative examples of the present invention are described in detail below with reference to the following Figure drawings:

FIG. 1 is an isographic ¾ view of the coffee maker;

FIG. 2 is a cutaway cross section of an isographic ¾ view of the coffee maker];

FIG. 3 is a side view of the coffee maker;

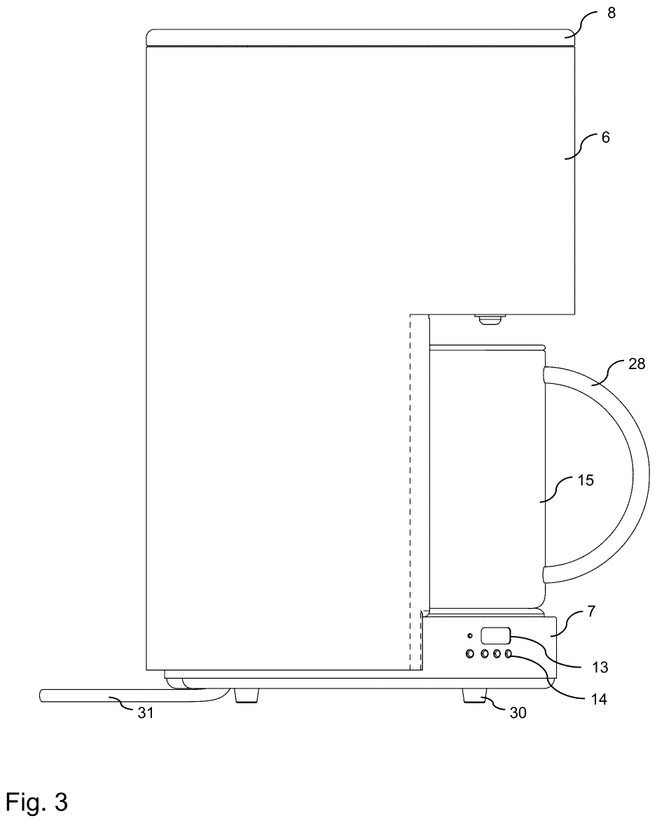

FIG. 4 is a front view of the coffee maker;

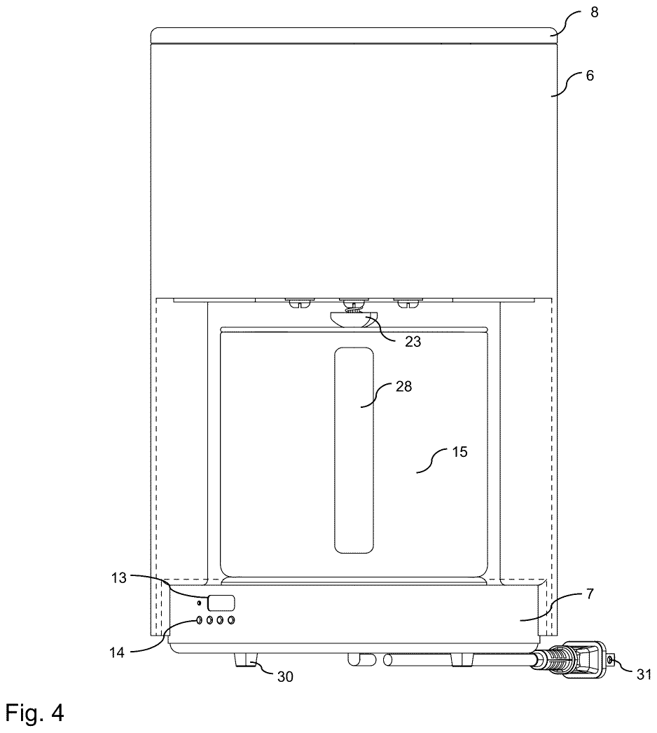

FIG. 5 is a top view of the coffee maker.

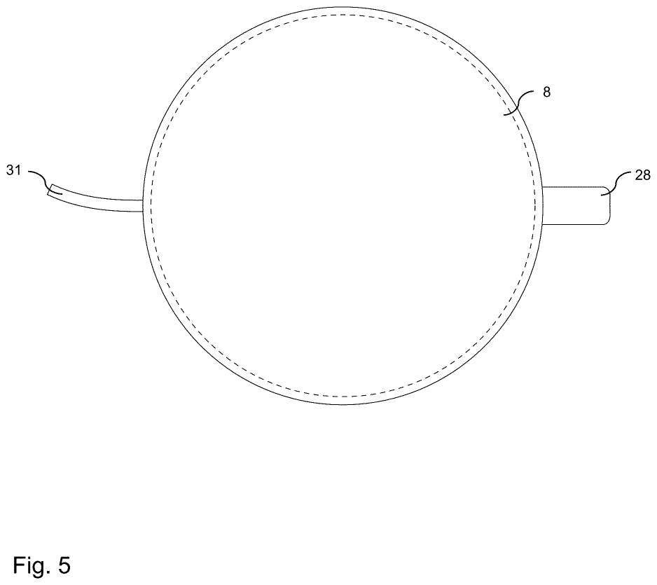

### DETAILED DESCRIPTION

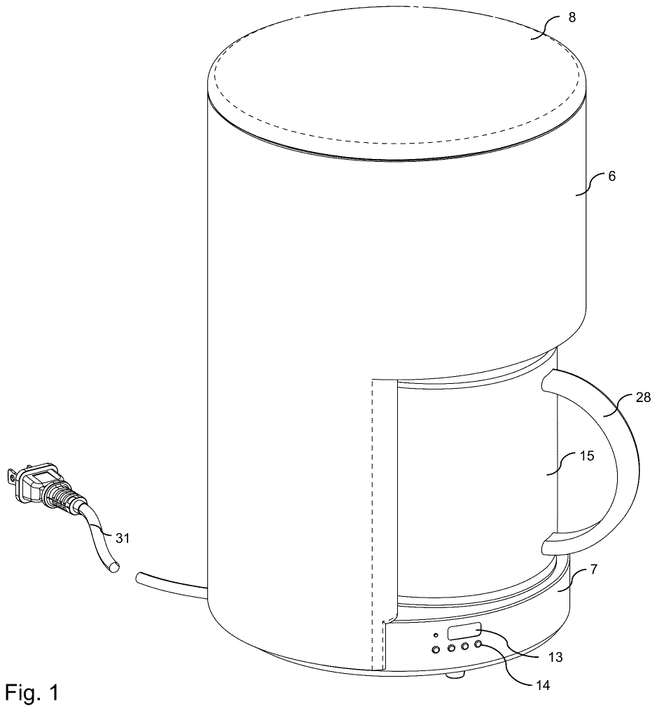

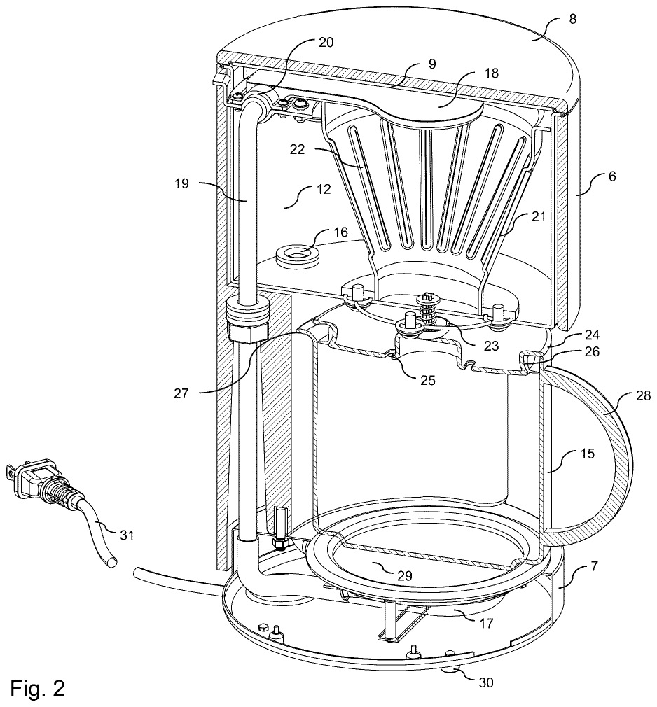

The embodiment of the invention shown in FIGS. 1 and 2 is a drip type coffee maker. The coffee maker comprises a housing 6 made of ceramic material that rests on a base 7 made of metal. The housing 6 has a lid 8, also made of ceramic material. Both the housing 6 and the lid 8 can receive various glazes and finishes. In one embodiment of the invention, the metal base 7 has two controls: an on/off control & a full carafe/half carafe control as well as an accompanying luminaire to indicate the selected full carafe/half carafe setting. In another embodiment of the invention the metal base 7 has an LED screen with a backlight 13. The LED screen displays the time and controls an automatic start function, allowing the coffee maker to start automatically at a time set by the user. Below the screen 13 are various control buttons 14 that are used to set the time and set automatic brewing times.

In one embodiment the lid 8 is operatively attached to a plate 9 connected to the housing 6 to allow removal of the lid to access the water reservoir 12 and the brew chamber 21. In another embodiment of the invention, the lid 8 is attached to a plate 9 connected to a post, which facilitates a swiveling function for the lid 8. Such function allows the user to move the lid in either direction (clockwise or counter-clockwise) to allow them to fill the water reservoir 12 with water. The water reservoir is made of stainless-steel, thus eliminating the conventionally plastic reservoir. The reservoir holds fresh water sufficient to brew a carafe 15 full of coffee. When activated, a heating element 17 in the base 7 of the coffee maker turns on. Water from the reservoir 12 passes through a water line connected to an aperture 16 in the bottom of the reservoir, and into the heating element 17. The water is heated sufficiently to push it up (i.e. percolate it up) a stainless steel riser 19 and into a stainless-steel shower 18.

In an alternative embodiment utilizing a flow-through heating system (instead of the percolation system depicted), the heating element 17 is NOT connected between the aperture 16 and the stainless-steel riser 19, and, therefore, heating element 17 is used ONLY for heating the carafe 15 as it rests on the recessed heating plate 29. Instead, water from the reservoir 12 passes through a water line (which can be food grade silicone or an inert food grade metal) connected to the aperture 16 and into a flow-through heating system. The flow-through heating system comprises: an integrated circuit, a water pump and a flow-through heater (with temperature sensors). The integrated circuit controls the water pump (flow rate) and the flow-through heater (temperature) to deliver precisely heated water into a hot-side brew path (comprising the heater, riser, shower, brew chamber). Preferably the water pump and flow-through heater are both NSF certified components, and the flow-through heater is plastic-free, thus ensuring food/beverage safe design, and the absence of plastic from the hot-side brew path (including the heater itself). The pressurized, heated water is delivered from the flow-through heating system via a water line to a stainless-steel riser 19 leading to the shower 18.

The stainless-steel shower pivots on a hinge 20 that allows the shower to be pivoted up so that the user can place a paper filter or a reusable coffee filter in the conical brew chamber 21. When in use, the shower 18 showers water over coffee grounds in the stainless-steel brew chamber and brewed coffee drips down the sides of the conical brew chamber 21 and into the glass carafe 15. Debossed fins 22 in the conical brew chamber aid in brewed coffee discharge from the brew chamber. At the bottom of the brew chamber is a spring-loaded stopper 23 that allows brewed coffee to discharge from the conical brew chamber only when a lidded glass carafe 15 is in place under the stopper. In one embodiment of the invention the carafe 15 is unique for its glass top 24. In another embodiment, the carafe top can be made from a non-reactive metal such as stainless steel. Carafe tops are commonly made of plastic, but the glass design of the present embodiment serves to eliminate plastic contact. The top has holes 25 in it that allow for brewed coffee to drip through the top 24 and into the carafe. At the edge of the lid is a silicone seal 26 that holds the coffee in the carafe except at the spout 27. The carafe has a handle 28 of glass.

The metal base provides a plastic-free, durable and strong support for the components above. The base has a large cutout that holds a recessed heating plate 29 that serves to keep brewed coffee in the carafe 15 warm. The metal base is held off the counter surface on which the coffee maker sits by anti-skid rubber feet 30 and has a hole in it which allows the power cord 31 to pass through.

1. An auto-drip coffee maker, comprising an upright ceramic body, a stainless-steel water reservoir, a stainless-steel water line, a heating element, a stainless-steel riser, a stainless-steel shower, and a stainless-steel brew chamber.

2. The auto-drip coffee maker described in claim 1, further comprising a glass carafe.

3. The auto-drip coffee maker described in claim 2, further comprising a carafe lid wherein the carafe lid consists of materials selected from the group consisting of glass and stainless steel.

4. The auto-drip coffee maker described in claim 3, wherein the carafe lid further comprises a silicone seal attached to the carafe lid such that the silicone seal is situated between the carafe lid and the carafe.

5. The auto-drip coffee maker described in claim 1, further comprising a metal base underneath the upright ceramic body.

6. The auto-drip coffee maker described in claim 5, wherein the metal base further comprises a set of controls.

7. The auto-drip coffee maker described in claim 6, wherein the set of controls further comprises an on/off control and a full carafe/half carafe control.

8. The auto-drip coffee maker described in claim 1, further comprising a textured surface on the upright ceramic body.

9. The auto-drip coffee maker described in claim 1, further comprising a glazed surface on the upright ceramic body.

10. The auto-drip coffee maker described in claim 1, further comprising a ceramic lid.

11. The auto-drip coffee maker described in claim 10, wherein the ceramic lid is operatively attached to the upright ceramic body, wherein the ceramic lid can be moved to allow access to the stainless-steel water reservoir and the stainless-steel brew chamber.

12. The auto-drip coffee maker described in claim 1, wherein the stainless-steel brew chamber further comprises an air gap insulated double-wall chamber.

13. The auto-drip coffee maker described in claim 12, wherein the stainless-steel brew chamber further comprises debossed fins.

14. The auto-drip coffee maker described in claim 1, wherein the stainless-steel water reservoir, the stainless-steel water line, the heating element, the stainless-steel riser, the stainless-steel shower, and the stainless-steel brew chamber are all free from hydrocarbon-based plastics.

15. An auto-drip coffee maker, comprising a metal base, an upright ceramic body, a stainless-steel water reservoir, a food-grade silicone water line, a flow-through heating system, a stainless-steel riser, a stainless-steel shower, and a stainless-steel brew chamber.

16. The auto-drip coffee maker described in claim 15, wherein the flow-through heating system comprises a water pump, a flow-through heater, a temperature sensor, and an integrated circuit controller.

17. The auto-drip coffee maker, described in claim 16, wherein the water pump is NSF-certified and the flow-through heater is NSF-certified.

18. The auto-drip coffee maker described in claim 16, further comprising a hot-side brew path, wherein said hot-side brew path comprises the flow-through heater, the temperature sensor, the food-grade silicone water line, the stainless-steel riser, the stainless-steel shower, and the stainless-steel brew chamber.

19. The auto-drip coffee maker described in claim 18, wherein the stainless-steel water reservoir and the hot-side brew path are all free from hydrocarbon-based plastics.

20. The auto-drip coffee maker, described in claim 18, wherein the stainless-steel water reservoir and the hot-side brew path are made from materials selected from the group consisting of: inert metals and food-grade silicone.
